(19) United States
(12) Patent Application Publication
(10) Pub. No.: US 2004/0242743 A1
(43) Pub. Date: Dec. 2, 2004

(54) Compositions formed from chlorinated polymers and articles manufactured using these compositions

(76) Inventors: Jean-Jacques Robin, Clapiers (FR); Dominique Tiffes, Villeveyrac (FR); Etienne Hannecart, Tervuren (BE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/485,825

(22) PCT Filed: Aug. 21, 2002
(86) PCT No.: PCT/EP02/09414

(30) Foreign Application Priority Data
Aug. 23, 2001 (FR) 01/1105

(51) Int. Cl. C08L 1/00

(52) U.S. Cl. 524/284

(57) ABSTRACT

Compositions comprising one or more polymers chosen from chlorinated polymers, and one or more salts of bismuth and of a carboxylic acid chosen from saturated hydroxy- and aminomonocarboxylic acids which have a total number of hydroxyl and amine groups with respect to the number of carbon atoms of greater than 1/10 and from saturated nonhydroxylated and nonaminated polycarboxylic acids. Articles or parts of articles manufactured using these compositions.

The present invention relates to compositions formed from chlorinated polymers and to articles and parts of articles manufactured using these compositions.

It is known that chlorinated polymers are difficult to ignite and, once ignited, they self-extinguish. In some specific cases, where very high resistance to ignition is needed, flame retardants specially provided for this purpose can be added thereto. They are very often organic or inorganic salts which are believed to be carcinogenic, such as antimony salts and arsenic salts.

In the same way, it is known that in proportion to chlorinated polymers being difficult to ignite, they give off a large amount of smoke during their combustion. There is nothing surprising in this to a person skilled in the art: this is because the latter knows that the flammability and ability to produce smoke are two entirely different problems, to a point such that some flame retardants promote the generation of smoke.

In addition, it is known that the smoke given off during fires by the combustion of articles or parts of articles prepared starting from compositions formed from chlorinated polymers according to the prior art can delay the involvement of the rescue services and consequently constitutes a serious problem. A new test for evaluating the behaviour of materials during fires, known as the “Single Burning Item test” is in the process of standardization by the competent bodies of the European Union. During this test, the materials are subjected to very severe conditions propitious to the evolution of smoke; it is planned to classify materials, with regard to their ability to produce smoke, by means of a “Smoke Growth Rate Index”.

Furthermore, another known problem relating to the compositions based on chlorinated polymers of the prior art is that, because they comprise chlorinated polymers, these compositions give off a large amount of heat during their combustion.

Patent U.S. Pat. No. 3,975,359 and Patent Application EP-A1-91706 thus disclose compositions formed from chlorinated polymers comprising various inorganic bismuth salts as smoke reducers. Such compositions have a heterogeneous content, the inorganic salts which they comprise dispersing poorly in the core of the polymer matrix. Furthermore, such compositions only moderately reduce the volume of the smoke, despite the inorganic bismuth salts which they comprise.

Patent Application EP-A1-90451 discloses compositions formed from vinyl chloride polymers comprising a bismuth salt derived from an α,β-ethylenically unsaturated aliphatic carboxylic acid. Although more compatible with vinyl chloride polymers and more effective with regard to smoke reduction than the abovementioned inorganic salts, these unsaturated organic salts only moderately reduce the volume of smoke. Furthermore, they result in the decomposition of the vinyl chloride polymers during processing (presence of numerous small black specks)

Patent CH 275161 discloses compositions formed from vinyl chloride polymers or vinylidene-chloride polymers comprising, as heat stabilizer, a salt of bismuth and of an organic acid, which acid is preferably a fatty acid having at least 12 carbon atoms. The numerous bismuth carboxylates mentioned in this patent, namely bismuth formate, acetate, butyrate, crotonate, laurate, palmitate, stearate, oleate, citrate, tartrate, maleate, benzoate and phthalate, only moderately reduce the volume of the smoke.

The object of the present invention is to overcome these disadvantages by providing polymer compositions which exhibit numerous advantages, in particular the advantage of giving off not very much smoke during their combustion.

To this end, the invention relates to polymer compositions comprising:

(A) one or more polymers chosen from chlorinated polymers;

(B) one or more salts of bismuth and of a carboxylic acid chosen from saturated hydroxy- and aminomonocarboxylic acids which have a total number of hydroxyl and amine groups with respect to the number of carbon atoms of greater than 1/10 and from saturated nonhydroxylated and nonaminated polycarboxylic acids.

The chlorinated polymers have a chlorine content usually of greater than 10%, preferably of greater than 40% and in a particularly preferred way of greater than 55%.

In addition, the chlorinated polymers have a chlorine content usually of less than 80%, preferably of less than 70% and in a particularly preferred way of less than 60%.

The term “chlorine content” of a polymer is understood to denote the weight of the chlorine present in this polymer with respect to the total weight of the polymer.

The chlorinated polymers are usually chosen from chlorinated vinyl polymers, chlorinated acrylic polymers and chlorinated polyolefins.

The term “chlorinated vinyl polymers” is understood to denote both the homopolymers of chlorinated vinyl monomers and the copolymers which these monomers form with one another or with ethylenically unsaturated monomers other than chlorinated vinyl monomers.

Mention may be made, as examples of chlorinated vinyl monomers, of vinyl chloride, vinylidene chloride, trichloroethylene, chloroprene and chlorotrifluoroethylene.

Mention may be made, as examples of ethylenically unsaturated monomers other than chlorinated vinyl monomers, of fluorinated vinyl monomers, such as vinylidene fluoride, vinyl esters, such as vinyl acetate, acrylic monomers, such as n-butyl acrylate, styrene monomers, such as styrene, or olefinic monomers, such as ethylene, propylene and butadiene.

The term “chlorinated acrylic polymers” is understood to denote both the homopolymers of chlorinated acrylic monomers and the copolymers which these monomers form with one another or with ethylenically unsaturated monomers other than chlorinated acrylic monomers.

Mention may be made, as examples of chlorinated acrylic monomers, of chloroacrylic esters and chloromethacrylic esters.

The term “chlorinated polyolefins” is understood to denote the polyolefins which comprise chlorine after having been subjected to a chlorination treatment.

Mention may be made, as examples of chlorinated polyolefins, of the high density polyethylenes which, after having been subjected to a chlorination treatment, have a chlorine content of between 20% and 70%.

The chlorinated polymers are preferably chlorinated vinyl polymers, in a particularly preferred way vinyl chloride polymers and in a very particularly preferred way vinyl chloride homopolymers.

The term “vinyl chloride polymers” is understood to denote both vinyl chloride homopolymers and the copolymers having at least 50% by weight of —CH₂—CHCl— units formed by vinyl chloride with ethylenically unsaturated monomers other than vinyl chloride.

Mention may be made, as examples of ethylenically unsaturated monomers other than vinyl chloride, of fluorinated vinyl monomers, such as vinylidene fluoride, vinyl esters, such as vinyl acetate, acrylic monomers, such as n-butyl acrylate, styrene monomers, such as styrene, or olefinic monomers, such as ethylene, propylene and butadiene.

The salt or salts of bismuth and of a carboxylic acid chosen under (B) can be prepared by any appropriate technique. They can be prepared in particular by reacting, in water and at ambient temperature, stoichiometric amounts of bismuth hydroxide and of a carboxylic acid, followed by filtration of the salts thus obtained.

The weight of (B) with respect to the weight of (A) usually has a value of at least 0.1%, preferably of at least 0.4% and in a particularly preferred way of at least 0.8%.

In addition, the weight of (B) with respect to the weight of (A) usually has a value of at most 100%, preferably of at most 25% and in a particularly preferred way of at most 12.5%.

In addition to (A) and (B), the polymer compositions according to the invention can optionally comprise (C) one or more substances chosen from diesters of phthalic, terephthalic and isophthalic acids, triesters of trimellitic acid, diesters of saturated aliphatic α,ω-dicarboxylic acids, acetylated or nonacetylated triesters of citric acid, triesters of phosphoric acid, alkylene glycol dibenzoates, alkylsulphonic esters of phenol and telomers of alkyl acrylates and methacrylates which have a number-average degree of telomerization of less than 8.

The substance or substances chosen under (C) usually exert a plasticizing effect on the polymer or polymers chosen under (A) and usually have a high compatibility with the latter. They are therefore often known as primary plasticizers.

The weight of (C) with respect to the weight of (A) usually has a value of 0 to 200%.

According to a first preferred alternative form, hereinafter denoted alternative form 1, the polymer compositions according to the invention comprise one or more salts of bismuth and of a carboxylic acid chosen from saturated hydroxy- and aminomonocarboxylic acids which have a total number of hydroxyl and amine groups with respect to the number of carbon atoms of greater than 1/10 (carboxylic acids B1).

Mention may be made, as examples of salts of bismuth and of a carboxylic acid B1, of

those of C₂ acids, such as bismuth glycolate and bismuth glycinate;

those of C₃ acids, such as bismuth lactate, bismuth glycerate, bismuth serinate, and bismuth α- and β-alaninates;

those of C₄-C₅-acids, such as bismuth 2-, 3- and 4-hydroxybutyrates, bismuth 2-hydroxyisobutyrate, bismuth 1-hydroxy-1-cyclopropanecarboxylate, bismuth threoninate, bismuth valinate, bismuth 2-, 3-, 4- and 5-hydroxyvalerates and bismuth 2-hydroxy-2-methylbutyrate;

those of C₆-C₇ acids, such as bismuth hydroxycaproates, bismuth hydroxyheptanoates and bismuth gluconate;

those of C₈-C₁₉ acids, such as bismuth hydroxycaprylates, hydroxynonanoates, dihydroxycaprates, dihydroxylaurates, dihydroxymyristates, dihydroxypalmitates and dihydroxystearates;

those of C_{≧20} acids, such as bismuth dihydroxyarachidates.

A first preferred characteristic of the carboxylic acids B1 is that they have a number of hydroxyl groups greater than the number of amine groups. In a particularly preferred way, they do not have an amine group.

A second preferred characteristic of the carboxylic acids B1 is that they have a number of hydroxyl groups with respect to the number of carbon atoms of greater than 1/10. The carboxylic acids B1 have, in a particularly preferred way, a number of hydroxyl groups with respect to the number of carbon atoms of greater than ⅛, in a very particularly preferred way of greater than ⅙, and in the most preferred way of greater than ¼.

A third preferred characteristic of the carboxylic acids B1 is that they have a number of hydroxyl groups with respect to the number of carbon atoms of less than ⅔. In a particularly preferred way, they have a number of hydroxyl groups with respect to the number of carbon atoms of less than or equal to ⅓.

A fourth preferred characteristic of the carboxylic acids B1 is that they have less than 20 carbon atoms.

In a particularly preferred way, they have less than 8 thereof; in a very particularly preferred way, they have less than 6 thereof; in the most preferred way, they have less than 4 thereof.

A fifth preferred characteristic of the carboxylic acids B1 is that they have more than 2 carbon atoms.

A sixth preferred characteristic of the carboxylic acids B1 is that they are aliphatic.

Preferably, the polymer compositions according to the alternative form 1 do not comprise a salt of bismuth and of a carboxylic acid other than the carboxylic acids B1. In a particularly preferred way, they comprise just one salt of bismuth and of a carboxylic acid, which salt is a salt of bismuth and of a carboxylic acid chosen from the carboxylic acids B1. In a very particularly preferred way, they comprise, as sole salt of bismuth and of a carboxylic acid, bismuth lactate.

The polymer compositions according to the alternative form 1 preferably comprise (C) one or more substances chosen from diesters of phthalic, terephthalic and isophthalic acids, triesters of trimellitic acid, diesters of saturated aliphatic α,ω-dicarboxylic acids, acetylated or nonacetylated triesters of citric acid, triesters of phosphoric acid, alkylene glycol dibenzoates, alkylsulphonic esters of phenol and telomers of alkyl acrylates and methacrylates which have a number-average degree of telomerization of less than 8.

The polymer compositions according to the alternative form 1 are such that the weight of (C) with respect to the weight of (A) preferably has a value of at least 10%, in a particularly preferred way of at least 20% and in a very particularly preferred way of at least 40%.

The polymer compositions according to the alternative form 1 are additionally such that the weight of (C) with respect to the weight of (A) preferably has a value of at most 150% and in a particularly preferred way of at most 100%.

According to a second preferred alternative form, hereinafter denoted alternative form 2, the polymer compositions according to the invention comprise one or more salts of bismuth and of a carboxylic acid chosen from saturated nonhydroxylated and nonaminated polycarboxylic acids (carboxylic acids B2).

Mention may be made, as examples of salts of bismuth and of a carboxylic acid B2, of:

those of C₂ acids, such as bismuth oxalate;

those of C₃ acids, such as bismuth malonate;

those of C₄ acids, such as bismuth succinate;

those of C₅ acids, such as bismuth glutarate and bismuth 1,1-cyclopropanedicarboxylate;

those of C₆-C₉ acids, such as bismuth adipate, bismuth pimelate, bismuth suberate, bismuth azelate, bismuth tricarballylate and bismuth 1,1- and 1,2-cyclobutanedicarboxylates;

those of C₁₀-C₁₅ acids, such as bismuth sebacate, bismuth dodecanedioate and bismuth tetradecanedioate;

those of C_{≧15} acids, such as bismuth thapsate.

A first preferred characteristic of the carboxylic acids B2 is that they are diacids.

A second preferred characteristic of the carboxylic acids B2 is that they have less than 15 carbon atoms.

In a particularly preferred way, they have less than 10 thereof; in a very particularly preferred way, they have less than 6 thereof; in the most preferred way, they have less than 4 thereof.

A third preferred characteristic of the carboxylic acids B2 is that they have more than 2 carbon atoms.

A fourth preferred characteristic of the carboxylic acids B2 is that they are aliphatic.

Preferably, the polymer compositions according to the alternative form 2 do not comprise a salt of bismuth and of a carboxylic acid other than the carboxylic acids B2. In a particularly preferred way, they comprise just one salt of bismuth and of a carboxylic acid, which salt is a salt of bismuth and of a carboxylic acid chosen from the carboxylic acids B2. In a very particularly preferred way, they comprise, as sole salt of bismuth and of a carboxylic acid, bismuth malonate.

The polymer compositions according to the alternative form 2 preferably comprise less than 10% by weight, with respect to the weight of (A), of (C) one or more substances chosen from diesters of phthalic, terephthalic and isophthalic acids, triesters of trimellitic acid, diesters of saturated aliphatic α,ω-dicarboxylic acids, acetylated or nonacetylated triesters of citric acid, triesters of phosphoric acid, alkylene glycol dibenzoates, alkylsulphonic esters of phenol and telomers of alkyl acrylates and methacrylates which have a number-average degree of telomerization of less than. 8. In a particularly preferred way, they do not comprise (C).

In addition to (A), (B) and optionally (C), the polymer compositions according to the invention can optionally comprise in particular (D) conventional additives of polymer compositions, such as heat stabilizers, impact reinforcers, secondary plasticizers, fillers, pigments, internal lubricants, external lubricants, diluents, viscosity regulators, swelling agents, accelerators of the decomposition of the swelling agents, fungicides, bactericides or odour modifiers.

The weight of (D) with respect to the weight of (A) usually has a value of 0 to 200%; it often has a value of 0 to 100%.

Mention may be made, as examples of heat stablizers, of organic tin, barium and zinc, calcium and zinc, cadmium and zinc, or lead salts.

Mention may be made, as examples of impact reinforcers, of alkyl acrylate homopolymers, such as poly(n-butyl acrylate), and methyl methacrylate polymers grafted to a polybutadiene support or to a support formed from a copolymer of styrene and of butadiene.

Mention may be made, as example of secondary plasticizer, of 2,2,4-trimethyl-1,3-pentanediol diisobutyrate TXIB®.

Mention may be made, as examples of fillers, of calcium carbonate, whether natural or precipitated, dolomite and silica.

Mention may be made, as examples of pigments, of titanium dioxide and carbon black.

Mention may be made, as example of internal lubricant, of stearic acid.

Mention may be made, as example of external lubricant, of hexadecane.

Mention may be made, as example of diluent, of kerosene.

Mention may be made, as example of viscosity regulator, of condensates of ethylene oxide with a fatty acid.

Mention may be made, as example of swelling agent, of azodicarbonamide.

Mention may be made, as example of accelerator of the decomposition of the swelling agents, of zinc oxide.

The polymer compositions according to the invention can be prepared conventionally by any known technique for blending or compounding.

The polymer compositions according to the invention are generally used conventionally, by applying known processing techniques, for manufacturing articles or parts of articles.

Mention may be made, as examples of processing techniques, of calendering (in particular for manufacturing films, sheets and plates), extrusion (in particular for manufacturing pipes and profiles), injection moulding (in particular for manufacturing seals and components), coating (in particular for manufacturing compact layers and cell layers), spraying (in particular for manufacturing mastics), dipping (in particular for manufacturing gloves) and moulding (for manufacturing various items).

Another subject-matter of the present invention is articles and parts of articles manufactured starting from compositions formed from chlorinated polymers, which exhibit numerous advantages. In particular, the articles and parts of articles according to the invention exhibit the advantage of giving off little in the way of smoke during their combustion.

To this end, the invention relates to the articles and the parts of articles manufactured using the polymer compositions according to the invention as defined above.

Mention may be made, as examples of such articles or parts of articles, of:

compact layers, films, sheets and plates;

pipes and tubes, or sheaths for cables;

leaktight materials, seals, crown caps, corrosion-resistant mastics and grit-resistant mastics;

cell layers and foams;

components, items or parts of items: gloves, dolls, and the like.

These can be flexible or rigid.

The polymer compositions, articles and parts of articles according to the invention have numerous advantages.

First of all, and although comprising chlorinated polymers, the compositions, articles and parts of articles according to the invention only give off a small amount of smoke during their combustion. From this viewpoint, they are favourably positioned in various tests for evaluating the behaviour towards fire of materials, in particular in the cone calorimeter test (ISO 5660-1).

In particular, the amount of smoke given off by the compositions according to the invention is less than the amount of smoke which is given off by the combustion of compositions based on chlorinated polymers and on bismuth salts known to a person skilled in the art. This comparison is also valid for the articles and the parts of articles manufactured starting from the corresponding compositions.

Subsequently, and although comprising chlorinated polymers, the compositions, articles and parts of articles according to the invention give off only a very small amount of heat during their combustion.

Finally, the compositions, articles and parts of articles according to the invention are very difficult to ignite, even in the absence of a specific flame retardant, such as the supposedly carcinogenic antimony salts and arsenic salts.

The polymer compositions according to the invention, on the one hand, and the articles and the parts of articles according to the invention, on the other hand, additionally have a number of advantages which are specific thereto.

With regard to the polymer compositions according to the invention, the latter have a homogeneous content; in particular, the bismuth carboxylates present therein are well dispersed in the core of the polymer matrix.

With regard to the articles and parts of articles according to the invention, the latter have a homogeneous colouring and homogeneous surface appearance; in particular, they do not exhibit, in the form of small black specks, a region of polymer material decomposed in the processing.

The examples which follow are intended to illustrate the invention without, however, limiting the scope thereof.

### EXAMPLE 1

### (Compositions and Flexible Plaques According to the Invention)

Blending

100 g of polymer Solvin® 271 GB (vinyl chloride polymer), 55 g of di[2-ethylhexyl] phthalate (DOP), 35 g of natural calcium carbonate, 5 g of heat stabilizer and 10 g of bismuth lactate were introduced into a receptacle. These ingredients were blended using a stirrer.

Mixing

The composition thus prepared was poured between the two heating rolls of a Collin® two-roll mill, after these rolls had been stabilized at a temperature of 165° C. The material which flowed out between the two rolls was collected in a tank placed under the latter, and was again poured between the two rolls. This procedure was carried out until the material forms a crepe.

Pressing

The crepes thus formed were pressed using a Lafarge® press so as to obtain sample plaques with a thickness of approximately 2 mm having a surface area of approximately 100 mm×100 mm.

Test of Behaviour Towards Fire

The sample plaques thus manufactured were subjected to the test of behaviour towards fire according to Standard ISO 5660-1, known as the cone calorimetry method, under the conditions stated below.

The sample plaques were incinerated under ambient air conditions while being subjected to external irradiance of 40 kW/m².

The results of the measurements which were collected are those which were necessary for the determination of the total specific volume of the smoke given off during the tests (Vₛₚ) and of the amount of specific heat (Qₛₚ) given off during the tests.

The term “total specific volume of the smoke given off during a test (Vₛₚ)” is understood to denote the total volume of the smoke given off during this test with respect to the initial weight of the sample plaque.

The term “volume of the smoke given off during a test” is understood to denote the volume which the smoke given off during this test occupies at a temperature of 70° C. and at atmospheric pressure (temperature and pressure conditions prevailing in the smoke analyser). It is expressed in m³/kg.

The term “amount of specific heat given off during a test (Qₛₚ)” is understood to denote the amount of heat given off during this test with respect to the initial weight of the sample plaque. It is expressed in kJ/g.

The results of the measurements are taken up in Table 1 below.

### EXAMPLE 2

### (Comparative Example)

The procedure was as in Example 2, except that the bismuth lactate was not added to the composition or that it was replaced, weight for weight, either by bismuth tartrate (I) or by bismuth maleate (II) or by bismuth terephthalate (III) or by bismuth formate (IV) or by bismuth acrylate (V).

The results of the measurements are taken up in Table 1 below.

TABLE 1

| | | |
|---|---|---|
| Nature of the composition from which | Vₛₚ | Qₛₚ |
| the plaque was manufactured | (m³/kg) | (kJ/g) |

Composition according to the invention

| | | |
|---|---|---|
| Composition comprising bismuth lactate | 34 | <1 |

Comparative examples

| | | |
|---|---|---|
| Composition without bismuth carboxylate | 71 | 12 |
| Composition comprising bismuth tartrate | 43 | 11 |
| Composition comprising bismuth maleate | 50 | 8 |
| Composition comprising bismuth | 46 | 13 |
| terephthalate | | |
| Composition comprising bismuth formate | 43 | 11 |
| Composition comprising bismuth acrylate | 44 | 10 |

### EXAMPLE 3

### (Compositions and Rigid Plaques According to the Invention)

100 g of polymer Solvin® 266RC (vinyl chloride polymer), 5 g of impact reinforcer (acrylic polymer), g of natural calcium carbonate, 5 g of titanium dioxide, 5 g of heat stabilizer and 10 g of bismuth malonate were introduced into a receptacle.

The procedure was subsequently as in Example 1, except that the heating rolls of the mixer were stabilized at a temperature of 185° C.

The sample plaques were incinerated under ambient air conditions while being subjected to external irradiance of 40 kW/m².

The results of the measurements are taken up in Table 2.

### EXAMPLE 4

### (Comparative Example)

The procedure was as in Example 3, except that the bismuth malonate was not added to the composition or that it was replaced, weight for weight, by the bismuth carboxylates (I) to (V) mentioned in Example 2.

The results of the measurements are taken up in Table 2.

TABLE 2

| | | |
|---|---|---|
| Nature of the composition from which | Vₛₚ | Qₛₚ |
| the plaque was manufactured | (m³/kg) | (kJ/g) |

Composition according to the invention

| | | |
|---|---|---|
| Composition comprising bismuth malonate | 14 | <1 |

Comparative examples

| | | |
|---|---|---|
| Composition without bismuth carboxylate | 47 | 9 |
| Composition comprising bismuth tartrate | 22 | <1 |
| Composition comprising bismuth maleate | 18 | <1 |
| Composition comprising bismuth | 20 | <1 |
| terephthalate | | |
| Composition comprising bismuth formate | 23 | <1 |
| Composition comprising bismuth acrylate | 17 | 11 |

### EXAMPLE 5

### (compositions and Rigid Plaques According to the Invention)

The procedure was as in Example 3, except that the amount of bismuth malonate was reduced to 1 g and that the plaques were subjected in the cone calorimeter to external irradiance of 60 kW/m².

The results of the measurements are taken up in Table 3.

### EXAMPLE 6

### (Comparative Example)

The procedure was as in Example 5, except that the bismuth malonate was not added to the composition or that it was replaced, weight for weight, by bismuth maleate.

The results of the measurements are taken up in Table 3.

TABLE 3

| | | |
|---|---|---|
| Nature of the composition from which | Vₛₚ | Qₛₚ |
| the plaque was manufactured | (m³/kg) | (kJ/g) |

Composition according to the invention

| | | |
|---|---|---|
| Composition comprising bismuth malonate | 36 | 7 |

Comparative examples

| | | |
|---|---|---|
| Composition without bismuth carboxylate | 50 | 11 |
| Composition comprising bismuth maleate | 43 | 11 |

1-17. (Canceled).

18. Polymer compositions comprising:
(A) one or more polymers chosen from chlorinated polymers;
(B) one or more salts of bismuth and of a carboxylic acid chosen from saturated hydroxy- and aminomonocarboxylic acids which have a total number of hydroxyl and amine groups with respect to the number of carbon atoms of greater than 1/10 and from saturated nonhydroxylated and nonaminated polycarboxylic acids.

19. The polymer compositions according to claim 18, wherein the chlorinated polymers are vinyl chloride polymers.

20. The polymer compositions according to claim 18, wherein the weight of (B) with respect to the weight of (A) has a value of at least 0.1%.

21. The polymer compositions according to claim 18, comprising one or more salts of bismuth and of a carboxylic acid chosen from saturated hydroxy and aminomonocarboxylic acids which have a total number of hydroxyl and amine groups with respect to the number of carbon atoms of greater than 1/10 (carboxylic acids B1).

22. The polymer compositions according to claim 21, wherein the carboxylic acids B1 have a number of hydroxyl groups greater than the number of amine groups.

23. The polymer compositions according to claim 21, wherein the carboxylic acids B1 have a number of hydroxyl groups with respect to the number of carbon atoms of greater than 1/10.

24. The polymer compositions according to claim 21, wherein the carboxylic acids B1 have less than 20 carbon atoms.

25. The polymer compositions according to claim 21, comprising as sole salt of bismuth and of a carboxylic acid, bismuth lactate.

26. The polymer compositions according to claim 21, additionally comprising (C) one or more substances chosen from diesters of phthalic, terephthalic and isophthalic acids, triesters of trimellitic acid, diesters of saturated aliphatic α,ω-dicarboxylic acids, acetylated or nonacetylated triesters of citric acid, triesters of phosphoric acid, alkylene glycol dibenzoates, alkylsulphonic esters of phenol and telomers of alkyl acrylates and methacrylates which have a number-average degree of telomerization of less than 8.

27. The polymer compositions according to claim 26, wherein the weight of (C) with respect to the weight of (A) has a value of at least 10%.

28. The polymer compositions according to claim 18, comprising one or more salts of bismuth and of a carboxylic acid chosen from saturated nonhydroxylated and nonaminated polycarboxylic acids (carboxylic acids B2).

29. The polymer compositions according to claim 28, wherein the carboxylic acids B2 are diacids.

30. The polymer compositions according to claim 28, wherein the carboxylic acids B2 have less than 15 carbon atoms.

31. The polymer compositions according to claim 28, comprising, as sole salt of bismuth and of a carboxylic acid, bismuth malonate.

32. The polymer compositions according to claim 28, comprising less than 10% by weight, with respect to the weight of (A), of (C) one or more substances chosen from diesters of phthalic, terephthalic and isophthalic acids, triesters of trimellitic acid, diesters of saturated aliphatic α,ω-dicarboxylic acids, acetylated or nonacetylated triesters of citric acid, triesters of phosphoric acid, alkylene glycol dibenzoates, alkylsulphonic esters of phenol and telomers of alkyl acrylates and methacrylates which have a number-average degree of telomerization of less than 8.

33. The polymer compositions according to claim 32, not comprising (C).

34. Articles and parts of articles manufactured using the polymer compositions according to claim 18.
